(19) United States
(12) Patent Application Publication
(10) Pub. No.: US 2008/0084694 A1
(43) Pub. Date: Apr. 10, 2008

(54) OPTICAL ELEMENT FOR A LIGHT-EMITTING DIODE, LED ARRANGEMENT AND METHOD FOR PRODUCING AN LED ARRANGEMENT

(76) Inventors: Monika Rose, Muenchen (DE); Sven Weber-Rabsilber, Neutraubling (DE); Alexander Wilm, Regensburg (DE)

Correspondence Address: FISH & RICHARDSON PC, P.O. BOX 1022, MINNEAPOLIS, MN, 55440-1022, US

(21) Appl. No.: 11/862,429

(22) Filed: Sep. 27, 2007

Related U.S. Application Data
(63) Continuation of application No. 60/860,943, filed on Nov. 24, 2006.

(30) Foreign Application Priority Data
Oct. 4, 2006 (DE) 10 2006 047 233.0

(51) Int. Cl. F21V 13/04; F21V 5/00; F21V 7/00

(52) U.S. Cl. 362/240; 362/257; 362/296; 362/308; 362/311; 362/317; 362/326

(57) ABSTRACT

An optical element comprises a radiation exit face for a light-emitting diode, said optical element being suitable for producing a radiation characteristic that breaks rotational symmetry, and a light-emitting diode comprising such an optical element, and an LED arrangement comprising a plurality of light-emitting diodes arranged on a carrier, wherein each of the light-emitting diodes is associated with its own optical element, which is arranged and configured such that a radiation characteristic of the respective light-emitting diode is formed with broken rotational symmetry, and wherein the optical elements are similarly implemented.

### CROSS-REFERENCE TO RELATED APPLICATIONS

This application claims priority under 35 U.S.C. 119(a) to German Patent Application 10 2006 047 233.0 filed Oct. 4, 2006 and also claims priority under 35 U.S.C. 119(e) to U.S. Provisional Application No. 60/860,943 filed Nov. 24, 2006, the contents of said applications are incorporated herein by reference.

### TECHNICAL FIELD

This disclosure relates to an optical element for a light-emitting diode (LED), a light-emitting diode comprising an optical element, an LED arrangement comprising a plurality of light-emitting diodes, and a method for producing an LED arrangement.

### BACKGROUND

To obtain different light distributions, LEDs are currently used with optics adapted to specific situations. Every new lighting application therefore has to have its own optic.

### SUMMARY

Disclosed herein are optical elements for one or more light-emitting diodes by means of which an LED arrangement having a plurality of light-emitting diodes and a defined radiation characteristic can be formed in a simplified manner. A light-emitting diode comprising such an optical element and an LED arrangement comprising a plurality of light-emitting diodes will further be specified. A method that simplifies the production of an LED arrangement having a defined radiation characteristic will also be specified.

In one embodiment, an optical element for a light-emitting diode is provided in which the radiation exit face is suitable for producing a radiation characteristic that breaks rotational symmetry. Such an optical element is particularly suitable for light-emitting diodes that are arranged on a carrier in an LED arrangement in cases where the LED arrangement is intended to have a defined radiation characteristic.

A light-emitting diode in one embodiment comprises a radiation exit side and an optical element, said optical element being arranged and configured such that the light-emitting diode has a radiation characteristic with broken rotational symmetry.

An LED arrangement in one embodiment comprises a plurality of light-emitting diodes arranged on a carrier, wherein each of the light-emitting diodes is associated with its own optical element, which is arranged and configured such that a radiation characteristic of the respective light-emitting diode is formed with broken rotational symmetry, and wherein the optical elements are similarly, particularly identically, implemented.

A radiation characteristic with broken symmetry, particularly rotational symmetry, is to be understood in particular as a radiation characteristic that deviates in a specified manner, for example with reference to an optical axis of the optical element, from a rotationally symmetrical radiation characteristic.

In the present context, only one optic with a non-radially-symmetrical radiation characteristic is needed. Different light distributions can be obtained with an LED arrangement by arranging individual or plural LEDs plus their optics on the carrier such that they are rotated by an angle of between 0° and 90°, preferably greater than 0° and less than 90°. The resulting light distribution is a combination of the light distributions of the individual LEDs. The angle of rotation between the individual LEDs plus optics can be the same or different.

By suitably rotating the LEDs provided with an optical element, and particularly by mounting them on the carrier in correspondingly rotated fashion, different lighting problems can be solved without having to newly adapt the optic to every situation. The optical element can be implemented, for example, as a lens, a reflector, or a combination of a lens and a reflector.

In particular, an extremely wide range of radiation characteristics can be obtained with an LED arrangement composed of LEDs equipped with similar optical elements, by arranging them such that they are rotated with respect to one another. Hence, the key advantage is that new light distributions can be obtained merely by adjusting the rotation of the LEDs, without the need to design and fabricate new optics. By suitably superimposing the respective off-rotational-symmetry radiation characteristics of the individual LEDs, the LED arrangement can be made to yield a defined radiation characteristic in a simple and cost-effective manner.

A defined radiation characteristic could also be obtained by developing an optical element specifically for the particular lighting situation (for example a lens, a reflector), but the radiation characteristic can also be varied in a simple manner via the arrangement of the LEDs relative to one another on the carrier.

The configuration of the carrier can also be used to influence the light distribution. For example, a mirror element or a plurality of mirror elements can be attached to or configured in the carrier. Furthermore, the carrier can be configured as flexible, so that the radiation characteristic of the LED arrangement can be varied by suitably bending the carrier.

The features described hereinafter with regard to an optical element and a light-emitting diode are applicable respectively to at least one optical element and at least one light-emitting diode of the LED arrangement, preferably respectively to all the optical elements and to all the light-emitting diodes of the LED arrangement. The use of similar, particularly identical, optical elements and light-emitting diodes simplifies the adaptation of the LED arrangement to the defined radiation characteristic.

In a preferred configuration, the radiation exit face of the optical element is configured as elongate in plan.

In particular, the ratio of a longitudinal extent (a) of the radiation exit face (40) of the optical element (4) to a transverse extent (b) of the radiation exit face (40) in a plan view of the radiation exit face is 1.5:1 or greater, preferably 2:1 or greater, particularly preferably 3:1 or greater, at most preferably 4:1 or greater.

The greater the ratio between the longitudinal extent and the transverse extent, the more the radiation characteristic is able to deviate from a rotationally symmetrical shape.

In a preferred configuration, the radiation exit face of the optical element has, in a plan view of the radiation exit face, at least two marked axes. The marked axes can in particular be perpendicular to each other.

In sectional planes that are each spanned by the optical axis and one of the marked axes, the radiation exit face preferably extends curvilinearly in each case.

Further preferably, the marked axes are axes of symmetry. The radiation exit face can thus be mirror-symmetrical to the marked axes.

In a further preferred configuration, the optical element, particularly the radiation exit face, has an ellipsoid-like shape when the radiation exit face is viewed in plan. A rotational-symmetry-free radiation characteristic for the optical element is easier to obtain in this way.

The optical element preferably contains a synthetic material, particularly a synthetic material from the group consisting of thermoplastic, duroplastic and silicone.

Alternatively or supplementarily, the optical element can contain a resin, particularly a resin from the group consisting of epoxy resin, acrylic resin and silicone resin.

Such an optical element is easier and less expensive to make than a glass lens, for example.

The optical element is further preferably implemented such that it can be attached to an LED via a material-locking connection, such as an adhesive bond. Alternatively or supplementarily, the optical element can be provided for mechanical connection to an LED, for example via a plug-in or snap-in connection, and can be equipped with suitable fasteners. The optical element can in particular be implemented as an attachment optic, for example an attachment lens.

In a preferred configuration, the LED is specifically configured with a radiation characteristic that breaks rotational symmetry. An optical element having at least one of the described features is particularly suitable for this purpose.

In particular, to produce a radiation characteristic that has no rotational symmetry, the optical elements of the individual LEDs are preferably configured as elongate in a plan view of their respective radiation exit sides.

In addition, the light-emitting diode expediently comprises at least one LED chip for generating radiation. The LED chip can, in particular, comprise an active region provided for generating radiation. The active region preferably contains a III-V compound semiconductor. III-V compound semiconductors are distinguished in particular by a high attainable internal quantum efficiency.

Radiation generated in the light-emitting diode, particularly in the LED chip, during operation expediently exits from the radiation exit side of the light-emitting diode through the radiation exit face of the optical element.

In a further preferred configuration, the light-emitting diode includes an LED component, said LED component comprising the LED chip and a housing. The LED chip is preferably disposed in the housing.

In a further preferred configuration, the optical element is formed by a portion of the housing that is configured to be reflective of the radiation generated in the LED chip. For example, the LED chip can be disposed in a cavity in the housing, with a wall of the cavity forming a reflector.

Alternatively or supplementarily, the optical element can be formed by a prefabricated optical element, for example an attachment lens, which is attached to the LED component, particularly to the housing.

Particularly preferably, the LED component is implemented as a surface-mountable device (SMD, surface mounted device). A component implemented in this way can be attached to a carrier in a simple manner. Whereas with a component of through-hole design, when the part is rotated relative to the carrier it is necessary at the very least to change the position of a recess in the carrier, an SMD component can be rotated relative to the carrier in a simple manner.

In a preferred configuration, the carrier of the LED arrangement is a connecting carrier having a plurality of connecting leads, the light-emitting diodes being electrically conductively connected to said connecting leads. The connecting carrier can be implemented as rigid or flexible. The connecting carrier can be a circuit board, for example. Carrying this further, the circuit board can be implemented as a metal-core circuit board (MCPCB, metal core printed circuit board).

The optical elements of the light-emitting diodes of the LED arrangement preferably have similarly shaped, particularly identical, radiation exit faces. The carrier can thus be fitted with a multiplicity of similar or identical light-emitting diodes, thereby simplifying the production of the LED arrangement.

The light-emitting diodes can be arranged on the carrier in the manner of grid points, for example in the form of a matrix or in the form of a honeycomb pattern.

In a preferred improvement, a direction of longitudinal extent of the optical element of a light-emitting diode or of a plurality of light-emitting diodes extends obliquely to an edge of the carrier. This makes it easier to obtain uniform radiation from the LED arrangement, particularly including in the corner regions of the carrier. An undesirable drop in the emitted radiant power toward the edge of the carrier, particularly in corner regions of the carrier, can thus be avoided or at least reduced in a simple manner.

In a further preferred configuration, optical elements are arranged rotated relative to one another with respect to their direction of longitudinal extent in a plan view of the carrier, particularly rotated by an angle of more than 0° and less than or equal to 90°. Rotating the optical elements relative to one another provides a simple way of matching the radiation characteristic of the LED arrangement to a defined radiation characteristic.

In a preferred improvement, the LED arrangement includes optical elements that are arranged parallel to one another and optical elements that are arranged obliquely to one another. For example, the LED arrangement can comprise plural groups of optical elements, the optical elements in each group being arranged parallel to one another and the directions of longitudinal extent of different groups being arranged rotated with respect to one another.

Further preferably, the light-emitting diodes are arranged such that the radiation characteristics of the light-emitting diodes superimpose to yield a defined radiation characteristic of the LED arrangement.

In a further preferred improvement, the defined radiation characteristic of the LED arrangement can be formed by rotating light-emitting diodes relative to one another. Merely rotating the light-emitting diodes relative to one another can be sufficient for this purpose. The positions of the light-emitting diodes on the carrier can thus be kept unchanged or substantially unchanged in order to form a defined radiation characteristic. In other words, the orientation of the optical elements, for instance in relation to the direction of longitudinal extent of the radiation exit face, represents an additional degree of freedom, besides the focal-point position of the light-emitting diode, that is available for influencing the radiation characteristic of the LED arrangement during its production.

In a variant configuration, the LED arrangement has an axis of symmetry, particularly preferably two axes of symmetry. The light-emitting diodes can be arranged symmetrically, particularly axially symmetrically, relative to this axis of symmetry or these axes of symmetry. A defined symmetrical radiation characteristic can thus be obtained for the LED arrangement in a simplified manner. For example, the light-emitting diodes in the corner regions of the carrier can be arranged symmetrically to one another, said light-emitting diodes being rotated relative to the light-emitting diodes in the inner region of the carrier.

Depending on the defined radiation characteristic of the LED arrangement, the light-emitting diodes can also be arranged in a manner that deviates from a symmetrical arrangement.

According to an exemplary embodiment of a method of configuring an LED arrangement comprising a plurality of light-emitting diodes, a desired radiation characteristic is defined for the LED arrangement. A multiplicity of light-emitting diodes with similar radiation characteristics is prepared, with the radiation characteristic of each light-emitting diode exhibiting broken rotational symmetry. A suitable number and a suitable arrangement of the light-emitting diodes for the desired radiation characteristic are determined. The previously determined suitable number of light-emitting diodes is arranged in the previously determined arrangement on a carrier for the LED arrangement, and the LED arrangement is finished with the desired radiation characteristic.

An LED arrangement having a defined radiation characteristic can be produced more simply in this way. In particular, the desired radiation characteristic can be set or at least approximated by rotating the light-emitting diodes relative to the carrier, and particularly also relative to one another. This eliminates the need for the onerous process of designing and implementing an optic for the plurality of light-emitting diodes that is specific to the application concerned and depends in each case on the defined radiation characteristic.

The described method is particularly suitable for the production of a described LED arrangement, so features described in connection with the LED arrangement can also be applied to the method and vice versa.

Additional aspects, features, and advantages follow from the following description of the exemplary embodiments made in conjunction with the drawings.

### DESCRIPTION OF DRAWINGS

FIGS. 1A to 1C show a first exemplary embodiment of an LED arrangement in a schematic oblique view in FIG. 1A, a schematic plan view in FIG. 1B and a schematic detailed sectional view in FIG. 1C,

FIG. 2 shows a second exemplary embodiment of an LED arrangement in a schematic plan view,

FIG. 3 shows a third exemplary embodiment of an LED arrangement in a schematic plan view, and

FIG. 4 shows a second exemplary embodiment of an LED arrangement in a schematic plan view.

Like, similar, and like-acting elements are provided with the same respective reference characters in the figures. The figures are all schematic representations and therefore are not necessarily true to scale. Rather, small elements may be depicted as exaggeratedly large for purposes of better understanding.

### DETAILED DESCRIPTION

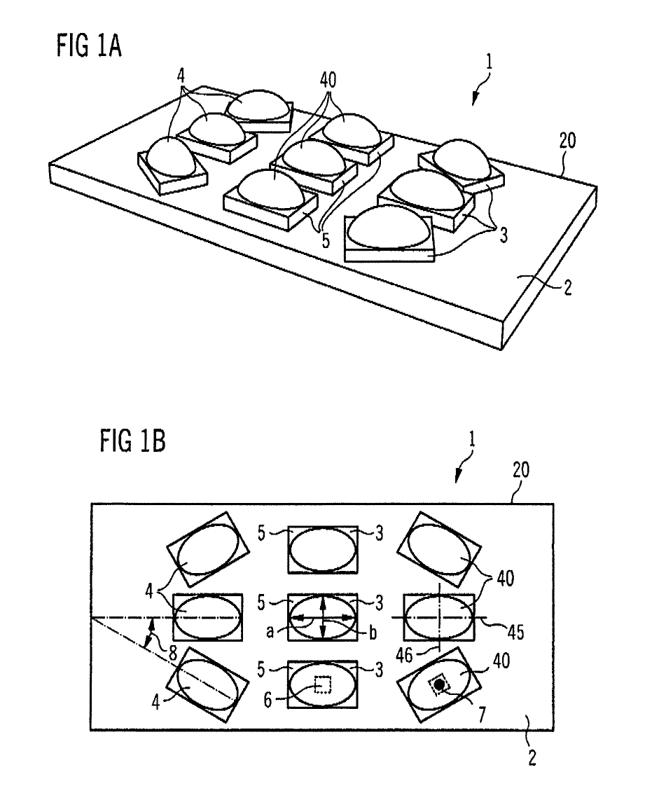

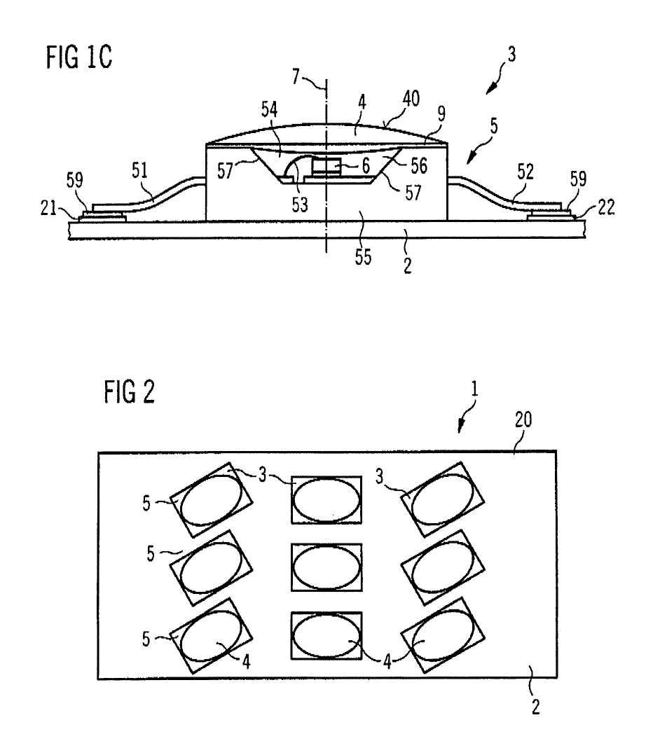

The first exemplary embodiment of an LED arrangement 1, illustrated schematically in FIGS. 1A to C, includes a carrier 2.

Attached to the carrier 2 is a plurality of light-emitting diodes 3, preferably three or more light-emitting diodes, particularly preferably six or more light-emitting diodes (nine light-emitting diodes are depicted by way of example). The carrier 2 can be rigid or flexible, and is further preferably implemented as a connecting carrier, for example as a circuit board, preferably a printed circuit board (PCB). Carrying this further, the connecting carrier can be implemented as a metal-core circuit board. The light-emitting diodes 3 are expediently configured as surface-mountable components and, on the connecting carrier, are electrically conductively connected to connecting leads, for example by gluing or soldering. This simplifies the mounting of the light-emitting diodes.

Specular or reflective elements that can be used to further influence the radiation characteristic of the LED arrangement (not explicitly illustrated) can additionally be configured in or on the carrier 2.

The radiation characteristic of the LED arrangement 1 can further be adjusted, particularly in the case of a flexible carrier 2, by curving the carrier 2.

The LED arrangement preferably includes light-emitting diodes for generating mixed-color light, particularly light that appears white to the human eye, for example in three primary colors such as red, green and blue.

Each of the light-emitting diodes 3 comprises a similar optical element 4 and an LED component 5. The optical element 4 is implemented as a separately prefabricated optical element, particularly as a lens, which is attached to the LED component 5. Where appropriate, the optical element can also be implemented as a reflector integrated into the LED component or as a combination of such a reflector with a lens (not shown). The present optical element 4 has a radiation exit face 40.

The optical element 4, as viewed from outside the element, can be configured with a radiation exit face 40 that is convexly curved, preferably continuously.

The optical element further has a first marked axis 45 and a second marked axis 46. Each radiation exit face can in particular be implemented as curved in sections taken along these marked axes.

The optical element 4 is implemented such that each of the light-emitting diodes 3 has a non-rotationally-symmetrical radiation characteristic.

The radiation characteristic can be determined, for example, by the dependence of the intensity of the radiation from the light-emitting diode on the angle formed with the optical axis. The optical axis 7 preferably extends through an LED chip 6 of the particular light-emitting diode 3. Particularly preferably, the optical axis 7 extends through a central region of radiation exit face 40. The optical axis can in particular extend perpendicularly to the surface of the LED chip 6 facing toward the optical element 4, and preferably perpendicularly to the radiation exit face 40.

The present optical element 4 is implemented as elongate, for example with a radiation exit face 40 that is ellipsoidal in plan. The long principal axis a can be 1.5 times or more as long, preferably twice or more as long, particularly preferably three times or more as long, at most preferably four times or more as long, than the short principal axis b of the ellipsis.

With the use of such an optical element 4, a radiation characteristic that has no rotational symmetry with respect to the optical axis 7 can be formed by beam-shaping or refracting the radiation generated in the LED chip 6. The LED chip expediently has an active region for generating radiation. Moreover, the LED chip, particularly the active region, contains a III-V semiconductor material. III-V semiconductor materials are particularly suitable for generating radiation in the ultraviolet (InₓGa_{y}Al_{1-x-y}N) through the visible (InₓGa_{y}Al_{1-x-y}N especially for blue to green radiation, or InₓGa_{y}Al_{1-x-y}P, especially for yellow to red radiation) to the infrared (InₓGa_{y}Al_{1-x-y}As) regions of the spectrum. In each of the foregoing cases, 0≦x≦1, 0≦y≦1 and x+y≦1, particularly with x≠1, y≠1, x≠0 and/or y≠0. In addition, advantageously high internal quantum efficiencies can be achieved when radiation is generated using III-V semiconductor materials, particularly from the aforesaid material systems. The optical element preferably contains a synthetic material, particularly a synthetic material from the group consisting of thermoplastic, duroplastic and silicone.

Alternatively or supplementarily, the optical element can contain a resin, particularly a resin from the group consisting of epoxy resin, acrylic resin and silicone resin.

An elongate, particularly ellipsoid-like, illuminance distribution can therefore be produced on a to-be-illuminated surface extending parallel to the carrier 2 if said surface is illuminated by means of a single light-emitting diode 3.

Despite the breaking of rotational symmetry, the radiation characteristic of the light-emitting diode can extend axially symmetrically to the optical axis. The illuminance distribution of the individual light-emitting diode on the surface to be illuminated then does not exhibit any islands of increased radiant power located away from the optical axis.

The radiation characteristic of the LED arrangement 1 is obtained by superimposing the radiation emitted by the individual light-emitting diodes 3.

If some or all of the optical elements 4 are arranged with the direction of longitudinal extent (for example, long main axis a) oblique, i.e. at an angle different from 0° and in particular also different from 90°, to an edge 20 of the carrier 2, then defined radiation characteristics for the LED arrangements, and thus also a defined illuminance distribution on a surface to be illuminated, can be obtained in a simplified manner.

The individual optical elements 4 are arranged rotated with respect to the carrier 2, which in particular is planar. The direction of rotation preferably extends azimuthally to the optical axis 7.

According to FIGS. 1A and 1B, the light-emitting diodes 3 are arranged grouped in a polygon, particularly a rectangle. The light-emitting diodes 3 are preferably arranged in a matrix-like manner. In deviation therefrom, another, preferably regular, arrangement, for example in a honeycomb pattern, may also be expedient.

The optical elements 4 of the corner light-emitting diodes are each rotated in their direction of longitudinal extent relative to the direction of longitudinal extent of the optical element 4 of an adjacent light-emitting diode (cf., for example, intermediate angle 8). The inner optical elements 4 are oriented in parallel in the longitudinal direction, particularly parallel to the carrier edge 20.

Diagonally opposite optical elements are arranged with their longitudinal directions parallel. Any decrease in the illuminance distribution toward the edges of the surface to be illuminated by the LED arrangement 1 can be reduced in this way. Homogeneous illumination of a surface is thereby simplified.

FIG. 1C is a schematic sectional view of a detail of the lighting arrangement illustrated in FIGS. 1A and 1B, showing only one light-emitting diode 3 arranged on the carrier 2.

The light-emitting diode 3 includes an LED component 5 comprising a housing 55. The LED chip 6 is disposed in a cavity 56 of the housing 55. A wall 57 of the cavity 56 forms a reflector. Such a wall is implemented as reflective of the radiation generated in the LED chip. To increase reflection, the wall can be provided with a coating if necessary. Radiation generated in the LED chip can be reflected from the wall 57 and deflected in the direction of the radiation exit face 40 of the optical element.

The reflector configured in the LED component 5 can be implemented as rotationally symmetrical to the optical axis. A radiation characteristic that has no rotational symmetry can also be formed by means of the correspondingly shaped optical element 4. However, the reflector can also be shaped so as to result in, or at least be conducive to, a radiation characteristic that breaks rotational symmetry. For example, the reflector can have a basic shape in plan that deviates from a circular shape, for instance an elliptical shape. An optic with a radiation characteristic that breaks rotational symmetry can therefore also be obtained by means of a reflector or a combination of a reflector with a lens.

The LED component comprises a contact lead 51 and a further contact lead 52, each of which is electrically conductively connected respectively to a terminal area 21 and to a further terminal area 22 on the carrier 2, for example via an electrically conductive connecting means 59, such as a solder. The contact leads 51, 52 are electrically conductively connected to the LED chip, it being possible to establish the electrically conductive connection of contact lead 51 by means of a bond wire 53.

Particularly to protect against external influences, such as moisture, the LED chip 6 and, if present, the bond wire 53 can be embedded in an encapsulant 56.

In FIG. 1C, optical element 4 is attached to LED component 5, particularly to housing 55, by means of an adhesive layer 9. Alternatively or additionally, the optical element can also be configured for mechanical connection, for example a plug-in, snap-in or snap-on connection.

Furthermore, in deviation from the illustrated exemplary embodiment, the optical element can project at least regionally outward laterally beyond the LED component 5, particularly beyond the housing 55.

In a method for producing an LED arrangement 1, a desired radiation characteristic can first be defined for the LED arrangement. A multiplicity of light-emitting diodes 3 having similar radiation characteristics can be prepared, with the radiation characteristic of each of the light-emitting diodes exhibiting a broken rotational symmetry. A suitable number and a suitable arrangement of the light-emitting diodes for the desired radiation characteristic can then be determined. For example, by increasing the number of light-emitting diodes, it is possible to increase the overall radiant power of the LED arrangement. The previously determined suitable number of light-emitting diodes, in the previously determined arrangement, can be disposed on and in particular attached to a carrier 2 for the LED arrangement. The radiation characteristic can be adjusted in particular by suitably orienting the light-emitting diodes 3, i.e. by rotating the light-emitting diodes 3 relative to one another or relative to a carrier edge 20. The light-emitting diodes 3 can be attached to the carrier 2, for example by soldering or gluing, in the provided position and orientation.

LED arrangements produced and finished according to this method can be implemented as described in connection with FIGS. 1A to 1C and 2 to 4.

LED arrangements whose radiation is matched to a defined desired radiation characteristic can also be produced in a simple manner by the described method.

FIG. 2 shows a second exemplary embodiment of an LED arrangement. This second exemplary embodiment is basically the same as the above-described first exemplary embodiment. It differs therefrom in that the light-emitting diodes 3 are arranged in a matrix-like manner, with the optical elements 4 of the light-emitting diodes 3 arranged in respective columns and with mutually parallel directions of longitudinal extent. In addition, the directions of longitudinal extent of the optical elements of light-emitting diodes in adjacent columns are oblique to each other in each case.

The directions of longitudinal extent of the light-emitting diodes 3 in the outer columns extend parallel to one another. The directions of longitudinal extent of the light-emitting diodes in the center column extend parallel to a carrier edge 20 of the carrier 2.

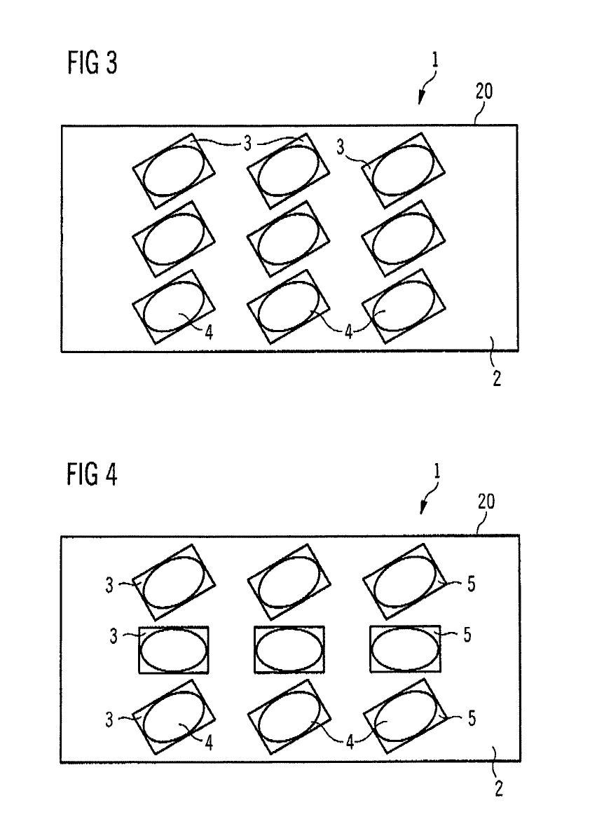

FIG. 3 shows a third exemplary embodiment of an LED arrangement. This third exemplary embodiment is basically the same as the second exemplary embodiment described in connection with FIG. 2. In contrast to the second exemplary embodiment, here all the optical elements 4 are arranged obliquely to the carrier edge 20, with the directions of longitudinal extent of all the optical elements extending parallel to one another. The directions of longitudinal extent of the optical elements 4 in adjacent columns therefore extend parallel to each other in each case.

FIG. 4 shows a fourth exemplary embodiment of an LED arrangement. This fourth exemplary embodiment is basically the same as the second exemplary embodiment described in connection with FIG. 2. In contrast to the second exemplary embodiment, here the optical elements 4 are arranged in rows with mutually parallel directions of longitudinal extent, with the directions of longitudinal extent of adjacent rows extending obliquely to each other. The directions of longitudinal extent of the outer rows extend parallel to each other.

Naturally, another arrangement and/or orientation of the directions of longitudinal extent of the optical elements 4 may be appropriate for the light-emitting diodes, depending on the defined radiation characteristic of the LED arrangement. A defined radiation characteristic of the LED arrangement 1 can be obtained in a simple manner by combining a suitable number of light-emitting diodes 3 and a suitable oblique position for the elongate optical elements 4 relative to one another and/or to the carrier edge 20.

Additional embodiments are within the scope of the following claims.

What is claimed is:

1. An optical element comprising a radiation exit face for a light-emitting diode, wherein said optical element is suitable for producing a radiation characteristic that breaks rotational symmetry.

2. The optical element as in claim 1,
whose radiation exit face is configured as elongate in plan.

3. The optical element as in claim 1,
wherein the ratio of a longitudinal extent (a) of said radiation exit face of said optical element to a transverse extent (b) of said radiation exit face when said radiation exit face is viewed in plan is 2:1 or greater.

4. The optical element as in claim 1,
wherein the ratio of a longitudinal extent (a) of said radiation exit face of said optical element to a transverse extent (b) of said radiation exit face when said radiation exit face is viewed in plan is 3:1 or greater.

5. The optical element as in claim 1,
wherein the ratio of a longitudinal extent (a) of said radiation exit face of said optical element to a transverse extent (b) of said radiation exit face when said radiation exit face is viewed in plan is 4:1 or greater.

6. The optical element as in claim 1,
wherein said radiation exit face of said optical element has, in a plan view of said radiation exit face, at least two marked axes.

7. The optical element as in claim 6,
wherein said axes are axes of symmetry.

8. The optical element as in claim 6,
wherein said radiation exit face extends curvilinearly in sectional planes each of which is spanned by an optical axis of said optical element and by one of said marked axes.

9. The optical element as in claim 1,
which is shaped as ellipsis-like in a plan view of said radiation exit face.

10. The optical element as in claim 1,
which is implemented as a lens.

11. A light-emitting diode comprising a radiation exit side and an optical element, wherein said optical element is arranged and configured such that said light-emitting diode has a radiation characteristic with broken rotational symmetry.

12. The light-emitting diode as in claim 11,
which is specifically configured with a radiation characteristic that breaks rotational symmetry.

13. The light-emitting diode as in claim 11,
wherein said optical element is implemented as a lens.

14. The light-emitting diode as in claim 11,
wherein said optical element is implemented as a reflector.

15. The light-emitting diode as in claim 11,
wherein said optical element is formed by a combination of a lens and a reflector.

16. The light-emitting diode as in claim 11,
which includes an LED chip for generating radiation.

17. The light-emitting diode as in claim 11,
which includes an LED component, said LED component comprising said LED chip and a housing and said LED chip being disposed in said housing.

18. The light-emitting diode as in claim 17,
wherein said LED component is implemented as surface-mountable.

19. The light-emitting diode as in claim 17,
wherein said optical element is formed by a portion of said housing that is configured as reflective of the radiation generated in said LED chip.

20. The light-emitting diode as in claim 17,
wherein said optical element is formed by a prefabricated optical element attached to said LED component.

21. The light-emitting diode as in claim 11,
wherein said optical element contains a synthetic material.

22. The light-emitting diode as in claim 21,
wherein said optical element contains a synthetic material from the group consisting of thermoplastic, duroplastic and silicone.

23. The light-emitting diode as in claim 11,
wherein said optical element contains a resin.

24. The light-emitting diode as in claim 11,
wherein said optical element contains a resin from the group consisting of epoxy resin, acrylic resin and silicone resin.

25. The light-emitting diode as in claim 11,
wherein said optical element is configured as elongated in a plan view of the radiation exit side.

26. The light-emitting diode as in claim 25,
wherein the ratio of the longitudinal extent (a) of said optical element to the transverse extent (b) of said optical element in a plan view of said radiation exit side is 2:1 or greater.

27. The light-emitting diode as in claim 25,
wherein the ratio of the longitudinal extent (a) of said optical element to the transverse extent (b) of said optical element in a plan view of said radiation exit side is 3:1 or greater.

28. The light-emitting diode as in claim 25,
wherein the ratio of the longitudinal extent (a) of said optical element to the transverse extent (b) of said optical element in a plan view of said radiation exit side is 4:1 or greater.

29. The light-emitting diode as in claim 11,
wherein a radiation exit face of said light-emitting diode has, in a plan view of said radiation exit face, at least two marked axes.

30. The light-emitting diode as in claim 29,
wherein said axes are axes of symmetry.

31. The light-emitting diode as in claim 11,
wherein said optical element is shaped as ellipsis-like in a plan view of said radiation exit side.

32. The light-emitting diode as in claim 11,
wherein said optical element is implemented in accordance with claim 1.

33. An LED arrangement comprising a plurality of light-emitting diodes arranged on a carrier, wherein each of said light-emitting diodes is associated with its own optical element, which is arranged and configured such that a radiation characteristic of the respective said light-emitting diode is formed with broken rotational symmetry.

34. The LED arrangement as in claim 33,
wherein said carrier is a connecting carrier having a plurality of connecting leads, and said light-emitting diodes are electrically conductively connected to said connecting leads.

35. The LED arrangement as in claim 33,
wherein said optical elements comprise similarly shaped radiation exit faces.

36. The LED arrangement as in claim 33,
wherein said light-emitting diodes are arranged on said carrier in the manner of grid points.

37. The LED arrangement as in claim 33,
wherein a direction of longitudinal extent of said optical element of a light-emitting diode or of a plurality of light-emitting diodes extends obliquely to an edge of said carrier.

38. The LED arrangement as in claim 33,
wherein said optical elements are arranged on said carrier such that they are rotated relative to one another with respect to their directions of longitudinal extent.

39. The LED arrangement as in claim 33,
wherein said optical elements are arranged parallel to one another with respect to their directions of longitudinal extent.

40. The LED arrangement as in claim 33,
which includes optical elements that are arranged parallel to one another and obliquely to one another with respect to their directions of longitudinal extent.

41. The LED arrangement as in claim 33,
wherein said light-emitting diodes are arranged such that the radiation characteristics of said light-emitting diodes superimpose to yield a defined radiation characteristic for the LED arrangement.

42. The LED arrangement as in claim 33,
wherein said defined radiation characteristic of said LED arrangement is formed by rotating light-emitting diodes relative to one another.

43. The LED arrangement as in claim 41,
wherein said defined radiation characteristic of said LED arrangement is formed by rotating light-emitting diodes relative to one another.

44. A method of configuring an LED arrangement having a plurality of light-emitting diodes, comprising:
a) defining a desired radiation characteristic for the LED arrangement;
b) preparing a multiplicity of light-emitting diodes having similar radiation characteristics, the radiation characteristic of each light-emitting diode with a broken rotational symmetry;
c) determining a suitable number and a suitable arrangement of the light-emitting diodes for the desired radiation characteristic;
d) arranging the previously determined suitable number of light-emitting diodes in the previously determined arrangement on a carrier for said LED arrangement; and
e) finishing the LED arrangement with the desired radiation characteristic.

45. The method as in claim 44, where the finished LED arrangement comprises an LED arrangement comprising a plurality of light-emitting diodes arranged on a carrier, wherein each of said light-emitting diodes is associated with its own optical element, which is arranged and configured such that a radiation characteristic of the respective said light-emitting diode is formed with broken rotational symmetry.
